(19) United States
(12) Patent Application Publication
(10) Pub. No.: US 2005/0196485 A1
(43) Pub. Date: Sep. 8, 2005

(54) Heat transfer system for a mold

(76) Inventors: Martin Cass, Port Clinton, OH (US); Shawn L. Overmyer, Fremont, OH (US); Bill Raubenolt, Fremont, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/034,691

(22) Filed: Jan. 13, 2005

Related U.S. Application Data
(60) Provisional application No. 60/481,888, filed on Jan. 13, 2004.

(51) Int. Cl. B29C 49/00

(52) U.S. Cl. 425/526

(57) ABSTRACT

An apparatus for facilitating heat transfer in a mold is disclosed. The apparatus includes a mold section having an external surface defining a concave-shaped channel, a hollow elongated member positioned within the channel, and a binding material attaching the hollow elongated member to the mold section. Heat transfers from the mold section to relatively cooler heat transfer fluid when the fluid is directed through the hollow elongated member. Heat may also transfer from the molded piece to the mold section when the fluid is transported through the hollow elongated member. The apparatus may have any number of channels and members. The hollow elongated member may be a copper tube and be completely or partially positioned within the channel. The mold section and binding material may be made of aluminum. A method of manufacture of the apparatus is also disclosed.

### FIELD OF THE INVENTION

The present invention relates to a heat transfer system and more particularly to a heat transfer system for a mold having improved thermal and economic properties.

### BACKGROUND OF THE INVENTION

Plastic molding is a process used to form substances into desired shapes. Typically, a plastic substance, in a fluid state, is placed into a mold by gravity or mechanical force. Most molds consist of two or more conjoined blocks, which are separated after the substance has solidified. The finished part is removed from the mold and the molding process is repeated. Certain post-mold process steps may be taken to finish the part.

Plastics may be molded using a variety of processes including blow molding, injection molding, compression molding, transfer molding, rotational molding and extrusion. Blow molding is basically a bulging process. A tubular piece of plastic is heated and then pressurized internally and expanded into the cavity of a relatively cool mold. Products made from blow molding are typically hollow, thin-walled containers or articles, such as two liter beverage containers.

One drawback of any molding process is that a mold has a tendency to heat up during use due to one or more factors, including friction, pressure or heat transfer from other components in the molding machinery. This undesired heat can cause production delays, safety issues to operators and potentially damage to the molds and molding machinery. Further, the setting of the molded part can be delayed. In some cases, it may be desirable to actively cool the mold to or below ambient temperature in order to facilitate the timely setting of the part within the mold. Therefore, it is conventional to use cast in internal tubing in molds to provide a heat transfer system to cool the molds. One such internal tubing system is disclosed in U.S. Pat. No. 6,659,750 to Overmyer et al., issued Dec. 9, 2003. After the molded part is formed, a heat transfer fluid such as water is directed through the internal tubes to cool the mold.

Heat transfer systems of this and other similar designs have certain undesirable limitations. The internal tubing must have sufficient strength to withstand the pressure and temperature conditions of the initial mold casting process. As a result, expensive material having less than optimal thermal properties are typically used, such as stainless steel. Further, once the tubing is in place, additions or modifications to the number or path of the cooling tubes is impractical. Therefore, what is needed in the art is a heat transfer system for molds offering improved thermal and economic properties.

The present invention provides a new and improved heat transfer system for a mold. The system uses copper tubing on an external surface of the mold rather than stainless steel internal pipes or tubes. This increases the thermal conductivity between the mold and the cooling fluid. Copper tubing is less expensive and easier to bend than stainless steel piping thereby reducing the overall material and labor costs of the molding process. Also, the external system is adaptable to a variety of molding processes and mold geometries. As a result, the present invention allows for a wide variety of initial system designs and easier modification or retrofitting of the coolant passages after initial use of the mold or modification of the mold cavity.

### SUMMARY OF THE INVENTION

A heat transfer system for facilitating heat transfer in a mold is disclosed. The system allows heat to transfer from a relatively cooler heat transfer fluid to a mold, mold base, or molded part.

The apparatus includes a mold and a hollow elongated member defining an enclosed passageway for transporting heat transfer fluid that is attached to the outside of the mold. The hollow elongated member may be tube shaped. More preferably, the hollow elongated member is a copper tube.

Further features and advantages of the invention will become apparent from the following detailed description made with reference to the accompanying drawings.

The Detailed Description of the Invention merely describes preferred embodiments of the invention and is not intended to limit the scope of the claims in any way. Indeed, the invention as described by the claims is broader than and unlimited by the preferred embodiments, and the terms in the claims have their full ordinary meaning.

### BRIEF DESCRIPTION OF THE FIGURES

FIG. 1 is a perspective view of a mold assembly constructed according to a first embodiment of the present invention;

FIG. 2 is a cross-sectional fragmentary view of a portion of the mold assembly illustrated in FIG. 1, showing a tube rigidly attached to an external surface of a mold base;

FIG. 3 is a perspective view of an apparatus constructed according to a second embodiment of the present invention;

FIG. 4 is a cross-sectional fragmentary view of a portion of the apparatus illustrated in FIG. 3, showing a tube rigidly attached within a channel defined by an external surface of a mold section;

FIG. 5 is a top view of a mold assembly constructed according to the first embodiment of the present invention, showing elongated hollow members running the length of the mold assembly; and

FIG. 6 is a cross-sectional view of the mold assembly of FIG. 5.

### DETAILED DESCRIPTION OF THE INVENTION

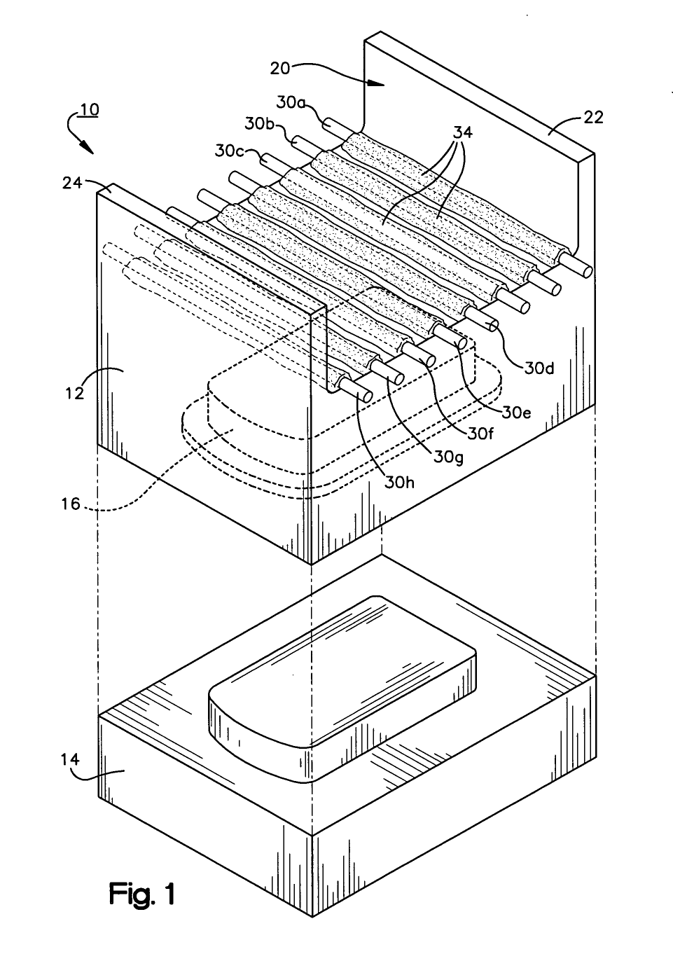

Referring now to the drawings, a perspective view of a mold assembly 10 constructed according to a first embodiment of the present invention is illustrated in FIG. 1. The mold assembly 10 includes a first block 12 and a second block 14. The blocks 12, 14 may be of any conventional design. For example, the blocks may be used for blow molding such that the first block 12 is a bushing block and the second block 14 is a pin block.

The first block 12 includes a mold cavity 16 in which a molded part is formed. In the practice of the present invention, the mold assembly 10 may include structure (not shown) necessary for blow molding, or any other suitable molding technique. As illustrated, the first block 12, and consequently the mold cavity 16, are shown in an upper position relative to the second block 14. The position shown is for exemplary purposes only to better illustrate the heat transfer system on the external surface of first block 12. In production use, the first block 12 would typically be positioned below the second block 14. Nonetheless, it should be understood by others with ordinary skill in the art that the invention can be practiced with a variety of mold styles and designs and is not limited to the embodiments illustrated herein.

The first block 12 includes an underside surface 20 on a side opposite the molding cavity 16. A majority of the surface 20 forms a planar section between two protruding leg supports 22, 24. Upon this planar section, a series of elongated tubes 30a, 30b, 30c, 30d, 30e, 30f, 30g, 30h are attached. The tubes are rigidly attached to the surface 20 by a binding material 34. To be discussed later in greater detail, the tubes 30a, . . . 30h are part of a heat transfer apparatus for facilitating heat transfer in the mold assembly 10. The tubes may be in fluid communication as a result of piping connections (not shown) to permit water to flow within a plurality of pipes.

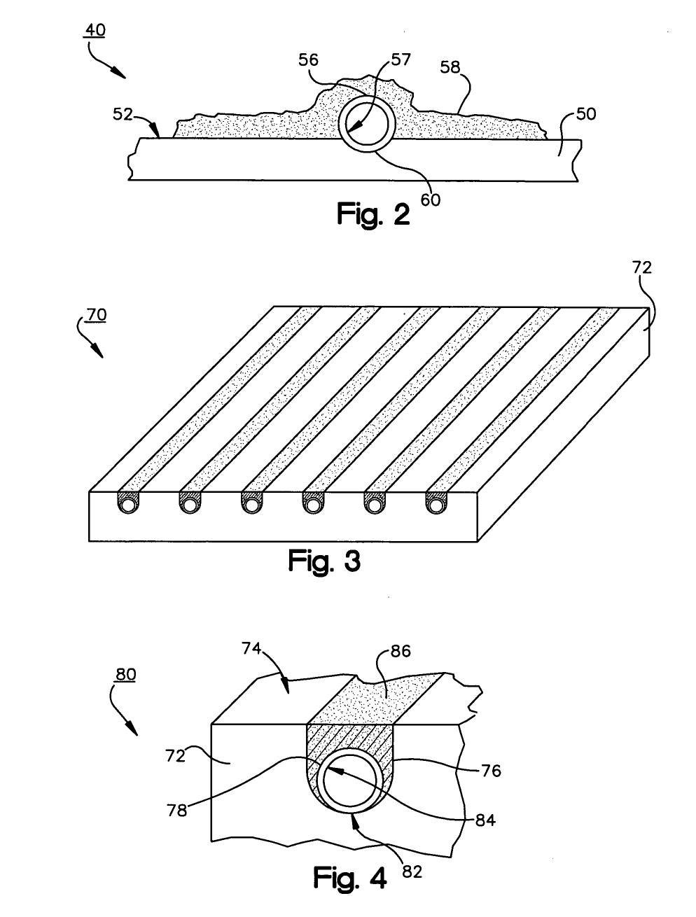

FIG. 2 is a cross-sectional fragmentary view of a portion 40 of the mold assembly illustrated in FIG. 1. A single tube rigidly attached to an external surface of a mold base is shown. The portion shown in FIG. 2 includes a base 50 having an external surface 52, a hollow elongated member 56 defining an enclosed passageway 57 for transporting heat transfer fluid and a binding material 58 attaching the hollow elongated member 56 to the external surface 52 of the base 50.

In the embodiment show in FIG. 1, the base 50 is a first block 12 of a two block mold assembly 10. In the practice of the invention, the base may be any side or section of a mold block or a mold partial or complete assembly. The base may also be a separate attachment which is connectable to an existing mold. The base may be formed from metal. In a preferred embodiment, the base has a thickness of ⅜ inches and is constructed of aluminum.

The base 50 structurally supports the elongated member 56. More specifically, the elongated member is held rigidly attached to the base by binding material 58. The elongated member 56 may be held contiguous to the planar external surface 52 by clips or other suitable tooling while the binding material is applied. Alternatively as shown in FIG. 2, the external surface 52 defines a channel 60 into which a portion of the hollow elongated member is positioned. The base may be provided with a channel on one or more of its surfaces. The channels may be formed by machining after the base is formed, or formed integrally with the base when the base is cast. The channel 60 may have a shape which is complementary to the shape of an exterior surface of the elongated member 56, although any channel shape may be used, such v-shaped or rectangular shaped. As a result, the enclosed passage may rest within the channel in a way which maximizes surface contact between the enclosed passage and channel. The base may have any number of channels in any type of configuration. The channels may have any depth. FIG. 2 shows a channel 60 depth in which less than one half of the height of the elongated member 56 is below the surface 52 of the base 50.

The hollow elongated member 60 defines an enclosed passageway 57 that serves to transport heat transfer fluid. By circulating a relatively cold material through the elongated member 56, the base 50 and mold attached thereto may be cooled. Concurrently, the recently molded part within the mold may be cooled by the mold. The hollow elongated member 56 may be formed in any configuration upon a surface or surfaces of the base. The elongated member may have any shape, but preferably is tubular. The elongated member may be made from any material, but is preferably copper due to copper's relatively high heat transfer efficiency. In a preferred embodiment, the elongated member is a ⅜ inch diameter copper tube.

As discussed, the binding material 58 functions to attach the hollow elongated member 56 to the external surface 52 of the base 50. The binding material also functions to facilitate heat transfer between the hollow elongated member and the base. The binding material may be an epoxy. Preferably, the binding material is a highly thermal conductive material such as a metal (e.g. aluminum) similar or identical to the base material. Thus, a superior joint may be formed between the binding material and the base.

The binding material may be applied continuously along the length of the enclosed passage as shown in FIG. 1, or only periodically. Periodic application reduces the heat transfer capacity of the overall system, but minimizes material usage and fabrication time.

Referring to any cross section of the elongated member 56, the binding material may be applied around part of or all of the circumference of that section. FIG. 2 illustrates binding material 58 applied around a majority of the circumference of the member 56. In a preferred embodiment also shown in FIG. 2, there is no binding material applied between the elongated member 56 and base 50 in the areas they abut each other. Typically, application around only a part of the circumference of the elongated member is necessary to affix the elongated member to the base. As previously stated however in regard to length, the more of the circumference which is covered, the better the heat transfer properties of the system.

As shown in FIG. 2, the binding material extends transverse from either side of the elongated member. The binding material may extended transversely from one side only, or from both sides of the elongated member generally equal or different distances. In a preferred embodiment, the binding material extends transversely from each side of the elongated member for a distance of about 3 to 5 times the diameter of the elongated member.

The binding material may be applied in any thickness to the surface of the base and elongated member. In a preferred embodiment, a layer of approximately ¼ to ⅜ inch of material is applied. Although not required, the binding material may be machined after application to remove any excess.

A perspective view of an apparatus 70 constructed according to a second embodiment of the present invention is illustrated in FIG. 3. FIG. 4 is a cross-sectional fragmentary view of a portion 80 of the apparatus 70 illustrated in FIG. 3. The apparatus 70 includes six parallel copper tubes rigidly attached within a metallic mold section. One of these six tubes is shown in FIG. 4 rigidly attached to a channel within an external surface of the mold section. As discussed, any number of tubes or tube patterns may be used in the practice of this invention.

In this embodiment, a mold section 72 constructed of aluminum or similar thermally conductive material is used. In the practice of the invention, the mold section 72 may be any top, bottom, side or plate addition to a conventional mold. The invention can be practiced on one or any combination of one or more surfaces in a mold.

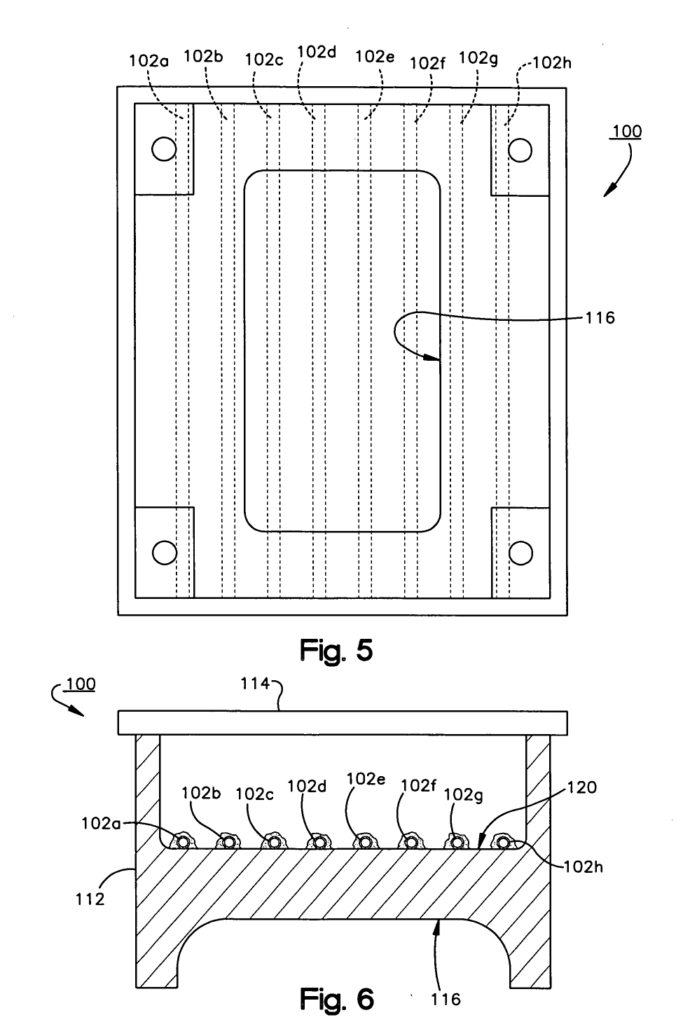

One example is illustrated in FIGS. 5 and 6. FIG. 5 is a top view of a mold assembly 100 constructed according to the first embodiment of the present invention. FIG. 6 is a cross-sectional view of the mold assembly of FIG. 5. The mold assembly 100 includes a mold block 112 and a back plate 114 for mounting to a platen. The mold block may be machined or cast. The mold block 112 defines a mold cavity surface 116 where a molded part is produced. The assembly has a series of eight copper tubes 102a, 102b, 102c, 102d, 102e, 102f, 102g, 102h that run essentially the length of the mold assembly. As shown in FIG. 6, the tubes are attached to an inner hollow surface 120 of the mold block 112. In a preferred embodiment of the invention, the tubes are placed as close as practical to the mold cavity surface 116 where the part is formed to increase cooling efficiency in regard to the molded part. Further, the back of the mold block 112 is often hollow to save material costs.

Referring again to FIG. 4, the mold section 72 has an external surface 74 that defines a channel 76. The channel may be made by machining or be preformed within the mold section 72. In FIG. 4, a channel is shown that is milled relatively deep into the surface 74 of the mold section 72. The channel may have any shaped bottom, e.g., annular, planar, v-shaped, but is preferably shaped to allow the copper tube to contact a maximum surface of the channel. As illustrated, the channel 76 has a depth greater than a diameter of a tube 78 attached within the channel. Preferably, the tube 78 rests on a bottom point 82 of the channel for maximum heat transfer.

The tube 78 is hollow and defines an enclosed passageway 84 for transporting heat transfer fluid. As a function of fluid being transported through the tube, heat transfers from the mold section 72 to the heat transfer fluid. Preferably, as a function of fluid being transported through the tube, heat also transfers from the molded part to the mold section 72.

As discussed, at least a portion of the tube 78 is positioned within the channel in this embodiment. The entire tube is within the channel in FIG. 4. At the top surface 74 of the mold section 72, the width of the channel 76 may be equal to the diameter of the tube 78. In this case, the tube may be tapped into place within the channel.

A suitable binding material 86 is used to attach the tube 78 to the mold section 72. The binding material may be an epoxy, or preferably is a spray metal such as aluminum. In an embodiment shown in FIG. 4, the tube 78 is fully below the top surface 74 of the mold section 72. In this case, the binding material 86 may be applied to the top of the tube in an amount which fills the channel 76. As such, the binding material and the tube may combine to fill a majority of a volume of the channel. Preferably, the entire channel is filled. Any excess binding material may be machined until it is flush with the top surface 74 of the mold section 72 as seen in FIG. 4.

A method of fabricating an apparatus for facilitating heat transfer in a mold includes the principle steps of positioning a hollow elongated member adjacent a mold section, applying a binding material upon at least a portion of an external surface of the hollow elongated member and upon at least a portion of an external surface of the mold section, and allowing the binding material to solidify. As a result, the hollow elongated member and the mold section become rigidly attached.

A preferred method for fabricating the system for facilitating heat transfer includes the following steps. First, the necessary channel pattern is machined into the mold block or mold block attachment, plate or section. Alternatively, the channel pattern may also be placed in the mold or attachment during its original casting. Next, the appropriate length of tubing is put in place within the channels. The passage material may be bent as required during this application step. The tubing may be tapped into place using a hammer in combination with a tool which will not damage the passage. The tubing may be deformed slightly, or mushroomed, in order to purge any air from between the channel and the tubing.

The next step is to rigidly attach the tubing to the channel. The tubing may be temporarily held in place using mechanical clips. Next, the binder is applied in a liquid form and allowed to solidify. If the binding material is a metal, its application may be made using a spray gun. An example of such a commercially available spray gun is the Wire-Fix 96 model spray gun by Addifix. The application process may be manually or computer controlled. After the binding material has solidified, excess material may be machined or ground off.

In the practice of the invention, the tubing can be attached by alternative techniques using other types of binding material. For example, the binding material may take the form of fasteners, clips, bolts or other connector designs. Preferably, these bindings are made of a highly thermal conductive material to increase the heat transfer efficiency of the overall apparatus.

While several embodiments of the invention has been illustrated and described in considerable detail, the present invention is not to be considered limited to the precise construction disclosed. Various adaptations, modifications and uses of the invention may occur to those skilled in the arts to which the invention relates. It is the intention to cover all such adaptations, modifications and uses falling within the scope or spirit of the claims filed herewith.

1. An apparatus for facilitating heat transfer in a mold comprising:
a base;
a hollow elongated member defining an enclosed passageway for transporting heat transfer fluid; and
a binding material attaching said hollow elongated member to the outside of said base.

2. The apparatus of claim 1 wherein said base is constructed of aluminum.

3. The apparatus of claim 1 wherein said hollow elongated member is tubular shaped.

4. The apparatus of claim 1 wherein said hollow elongated member is a copper tube.

5. The apparatus of claim 1 wherein said binding material attaches to a majority of a circumferential surface of said hollow elongated member.

6. The apparatus of claim 1 wherein said binding material attaches to a majority of a length of said hollow elongated member.

7. The apparatus of claim 1 wherein an external surface of said base defines a channel into which a portion of said hollow elongated member is positioned.

8. The apparatus of claim 1 wherein said binding material is an epoxy.

9. The apparatus of claim 1 wherein said binding material comprises a metal.

10. The apparatus of claim 1 wherein said binding material comprises aluminum.

11. An apparatus for facilitating heat transfer in a mold when used to manufacture a molded part, said apparatus comprising:
a mold section having an external surface defining a channel;
a hollow elongated member defining an enclosed passageway for transporting heat transfer fluid, wherein at least a portion of said hollow elongated member is positioned within said channel; and
a binding material attaching said hollow elongated member to said mold section, wherein heat transfers from said mold section to said heat transfer fluid as a function of said fluid being transported through said hollow elongated member.

12. The apparatus of claim 11 wherein said mold section and said binding material are comprised of aluminum.

13. The apparatus of claim 11 wherein said binding material is an epoxy.

14. The apparatus of claim 11 wherein said hollow elongated member is a copper tube.

15. The apparatus of claim 11 wherein said binding material and said hollow elongated member combine to fill a majority of a volume of said channel.

16. The apparatus of claim 1 1 wherein said channel has an annular bottom surface adapted to cooperatively abut with an exterior surface of said hollow elongated member.

17. The apparatus of claim 11 wherein said channel has a planar bottom surface.

18. The apparatus of claim 11 wherein said channel has a V-shaped bottom surface.

19. The apparatus of claim 11 wherein heat transfers from said molded part to said mold section as a function of said fluid being transported through said hollow elongated member.

20. The apparatus of claim 11 wherein said hollow elongated member is a tube and said channel has a depth at least as great as an outer diameter of said tube.

21. The apparatus of claim 11 wherein a majority of said hollow elongated member is positioned entirely within said channel.

22. A method of fabricating an apparatus for facilitating heat transfer in a mold comprising the steps of:
positioning a hollow elongated member adjacent a mold section;
applying a binding material upon at least a portion of an external surface of said hollow elongated member and upon at least a portion of an external surface of said mold section; and
allowing the binding material to solidify, whereby said hollow elongated member and said mold section rigidly attach.

23. The method of claim 22 further including the step of forming said mold section from a liquid material and allowing said mold section to solidify.

24. The method of claim 22 further including the step of forming said mold section from a liquid material and allowing said mold section to solidify, wherein said mold section has an external surface defining at least one concave-shaped channel.

25. The method of claim 22 further including the step of machining at least one concave-shaped channel into an external surface of said mold section.

26. A mold used to manufacture a molded part, said mold comprising:
a mold block having a surface defining a channel;
a copper tube for transporting heat transfer fluid, wherein at least a portion of said tube is positioned within said channel; and
a binding material attaching said tube to said mold block, wherein heat transfers from said mold block to said heat transfer fluid as a function of said fluid being directed through said tube.

27. A system for facilitating heat transfer in a mold comprising:
a base;
an enclosed passage for transporting heat transfer fluid, said enclosed passage supported by said base; and
a solidified binding material attaching said enclosed passage to said base.

28. The system of claim 27 wherein said base and said solidified binding material are aluminum.

29. The system of claim 27 wherein said enclosed passage is a copper tube.

30. The system of claim 27 wherein said binding material covers a circumferential surface of a section of the enclosed passage which is not covered by the base.

31. The system of claim 27 wherein said base includes a channel into which said enclosed passage may fit.

32. The system of claim 31 wherein said channel has an shape similar to the exterior shape of a portion of the enclosed passage adjacent to said base.

33. The system of claim 27 wherein said solidified binding material is epoxy.

34. A method of fabricating a system for facilitating heat transfer in a mold comprising the steps of:
supporting an enclosed passage upon a base;
displacing a binding material upon the enclosed passage and base; and
allowing the binding material to solidify.

35. The method of claim 34 further including the step of attaching the base to a mold.

36. The method of claim 34 further including the step of forming the base from a liquid material and allowing the base to solidify.
